(19) United States
(12) Patent Application Publication
(10) Pub. No.: US 2011/0219814 A1
(43) Pub. Date: Sep. 15, 2011

(54) TUBULAR HEAT EXCHANGER FOR MOTOR VEHICLE AIR CONDITIONERS

(75) Inventors: Artem SERYI, Wiesbaden (DE); Lothar SEYBOLD, Nauheim (DE)

(73) Assignee: GM GLOBAL TECHNOLOGY OPERATIONS LLC, Detroit, MI (US)

(21) Appl. No.: 13/044,161

(22) Filed: Mar. 9, 2011

(30) Foreign Application Priority Data
Mar. 9, 2010 (DE) 102010010625.9

(51) Int. Cl. F25B 1/00; F28D 7/10; B23P 15/26

(52) U.S. Cl. 62/498; 165/154; 29/890.053

(57) ABSTRACT

A tubular heat exchanger is provided for a motor vehicle air conditioner with an inner tube through which a fluid or gas can flow and an outer tube radially enclosing the inner tube subject to the formation of an intermediate space through which a flow can flow. The inner tube and the outer tube are at least radially fixed to each other by means of a number of stampings radially worked into the outer tube.

### CROSS-REFERENCE TO RELATED APPLICATION

This application claims priority to German Patent Application No. 102010010625.9, filed Mar. 9, 2010, which is incorporated herein by reference in its entirety.

### TECHNICAL FIELD

The technical field relates to a tubular heat exchanger for a motor vehicle air conditioner and in particular to a double-walled heat exchanger tube with an inner tube through which a fluid or a gas can flow and an outer tube radially enclosing the inner tube subject to the formation of an intermediate space through which a flow can flow.

### BACKGROUND

The use of double-walled heat exchanger tubes, so-called coaxial heat exchangers is quite known for motor vehicle air conditioners. Such a double-walled tube is described for example in DE 10 2005 052 972 A1. In this case, the inner tube is provided with grooves continuously running linearly in longitudinal direction or helically in a circumferential manner. Such grooves are intended to enlarge the cross-sectional area of a channel or annular gap running between inner and outer tube, so that the flow resistance of the refrigerant flowing in said outer channel or annular gap can be reduced.

Typical application scenarios for example provide that the inner tube of the heat exchanger fluidically connects the evaporator to the compressor of a vehicle air conditioner, and that the outer tube fluidically interconnects the condenser and the expansion device of the air conditioner. The respective refrigerants flow in the interior of the inner tube and in the intermediate space between inner and outer tube in opposite direction. The high-temperature high-pressure refrigerant typically flowing in the outer channel in the process passes thermal energy on to the low-pressure refrigerant flowing from the evaporator to the compressor. In this manner, the efficiency of motor vehicle air conditioners can be increased in a simple manner.

For manufacturing known coaxial tube heat exchangers, two different methods are currently under consideration. Thus, for supporting the two tubes relative to each other, it is either provided to continuously form at least one of the two tubes in longitudinal direction before the tubes are pushed inside each other. The manufacture of such longitudinally-formed tubes however is relatively involved and therefore cost-intensive.

As an alternative to this it can be provided to manufacture extruded profiles, for example an inner tube, with webs radially standing away to the outside and extending in tube longitudinal direction and to insert this extruded inner tube approximately designed star-shaped in cross section into a suitable outer tube. On the one hand, a provision of longitudinally-formed or extruded tube profiles with high dimensional stability is required with such manufacturing methods so that inner and outer tube form a non-positive connection when joined within each other. On the other hand, it proves disadvantageous that the inner tube with its webs radially protruding to the outside and continuously extending in tube longitudinal direction forms individual chambers in the intermediate space between inner and outer tube.

Swirling of the fluid flowing in the intermediate space between inner and outer tube favoring the heat exchange is thus only conditionally possible. In addition, when inserting the inner tube into the outer tube metal chips could accumulate, which would have to be most carefully removed before an installation of the double-walled heat exchanger tube in the air conditioner. Since with known manufacturing methods a non-positive connection of the tubes is formed even when inserting the inner tube into the outer tube, the joining within each other of the tubes additionally requires a correspondingly high expenditure of force.

It is therefore the at least one object to provide a tubular heat exchanger for a motor vehicle air conditioner that can be manufactured in a particularly simple manner and additionally cost-effectively. In addition, it is desirable to be able to favor the formation of heat transfer-promoting fluid or gas flows and provide an improved heat exchange. In addition, objects, desirable features and characteristics will become apparent from the subsequent summary and detailed description, and the appended claims, taken in conjunction with the accompanying drawings and this background.

### SUMMARY

The tubular heat exchanger is designed for a motor vehicle air conditioner and has an inner tube through which a fluid or a gas and/or a fluid-gas mixture can flow. The coaxial heat exchanger comprises an outer tube, which radially encloses the inner tube subject to the formation of an intermediate space through which a flow can flow. In an installation situation of the heat exchanger in the refrigerant circuit of a vehicle air conditioner it is more preferably provided in this case that the inner tube fluidically interconnects an evaporator and a compressor of the air conditioner, while the channel formed between inner tube and outer tube makes available a fluidic connection between a condenser and an expansion device of the refrigerant circuit.

By means of the coaxial heat exchanger a heat transfer of the high-pressure or high-temperature refrigerant flowing on the outside to the low-pressure or low-temperature refrigerant flowing in the inner tube in the opposite direction can thus take place. Here, cooling down of the high-temperature, high-pressure refrigerant can take place even before flowing through the expansion device connected downstream, with the help of which the refrigerant flowing to the evaporator is cooled down because of an isentropic or adiabatic expansion.

For the alternating fixing of outer tube and inner tube a number of stampings radially worked inwardly into the outer tube is provided, which fix at least the inner tube and the outer tube relative to each other in radial direction, that is substantially perpendicularly to the tube longitudinal extension. The stampings in this case are worked into the outer tube only once the inner tube is arranged within the outer tube.

In this manner, the manufacture or the assembly of such coaxial tube heat exchangers can be substantially simplified. The pushing into each other of inner and outer tube can for example be effected manually, without the help of possible tools. In the following, it merely has to be ensured that the stampings provided for the fixing of inner and outer tube are worked into the outer tube in a controlled manner.

Here it is preferable to provide that the stampings provided in the outer tube are locally worked into the outer tube in several locations spaced from one another. The extent of a respective stamping is comparatively small compared with the tube diameter. Each of the stampings on the outer tube radially protruding inwardly can thus form a local support point for the inner tube located in the outer tube.

According to a first embodiment it is provided that the outer tube in the region of the stampings is plastically deformed. This means that when working the stampings into the outer tube the elastic yield limit of the outer tube material is exceeded and possible elastic resetting forces of the outer tube material are substantially cancelled out or equalized.

According to a further embodiment the stampings form a non-positive connection of outer and inner tube. Accordingly, the stamping depth of the stampings to be worked into the outer tube is so great that the inner tube is fixed in the outer tube both in axial as well as in radial direction.

According to a further embodiment it is provided that the stamping depth of the stampings worked into the outer tube is greater than the clear spacing between outer tube inner wall and inner tube outer wall, assuming a concentric arrangement of inner and outer tube. With such a configuration it is more preferably provided that the stampings worked into the outer tube advance as far as into the inner tube and in the region of the outer tube stampings co-stamp also the inner tube in a manner of speaking.

According to a further embodiment it is more preferably provided here that the stampings worked into the outer tube for forming a positive connection of inner and outer tube at least in certain regions lie in corresponding stampings of the inner tube. The inner tube stampings in the process can be due to the stampings worked into the outer tube from the outside.

According to a further embodiment it is additionally provided that the stampings worked into the outer tube are identifiable in form of inner wall protrusions on the inside of the inner tube. This means, the stamping depth of the stampings worked into the outer tube is of such a magnitude that not only the outside but also the inside of the inner tube is subjected to a corresponding local, preferentially plastic deformation radially directed inwardly. Such stampings protruding into the inner tube or wall protrusions are advantageous for the swirling of the fluid, gas or fluid-gas mixture in the inner tube, which ultimately can lead to an improved heat exchange.

According to a further embodiment it is provided that in a plane perpendicularly to the tube longitudinal extension several stampings arranged distributed in circumferential direction of the tube are provided. The stampings lying in a common cross-sectional plane in this case, seen in circumferential direction of the tube, are preferentially arranged equidistantly or distributed in a regular manner. If for example three stampings are provided in circumferential direction, these are spaced approximately 120° relative to one another along the tube circumference. In the case of four stampings, the spacing angle of adjacent stampings is approximately 90° and with six stampings, approximately 60° etc.

According to a further embodiment it is additionally provided that several stampings spaced from one another in tube longitudinal direction are provided. Each of these can lie in common cross-sectional planes of the outer tube or of the tubes nested into each other. Here it can be provided that the stampings lying in different cross-sectional planes in tube longitudinal direction are rotated in tube circumferential direction, or are arranged parallel or aligned with one another.

Thus it can be more preferably provided that stampings spaced and adjacent in tube longitudinal direction are centrally offset relative to one other seen in tube circumferential direction. If for example three stampings are provided in a common cross-sectional plane stampings arranged adjacently in longitudinal direction can for example be arranged offset relative to one another by approximately 60° in tube circumferential direction.

According to a further embodiment it is provided that the spacing of the stampings arranged adjacently in tube longitudinal direction corresponds to 5 to 15 times, preferentially approximately 10 times the radial extension of the intermediate space gap dimension between inner tube and outer tube. Advantageously it is additionally provided that the spacing of stampings arranged adjacently in tube longitudinal direction is between approximately 10 mm and approximately 30 mm, preferentially between approximately 15 mm and approximately 25 mm. In this case, the stampings can be formed approximately over the entire tube length in cross-sectional planes that come to be located equidistantly from one another.

Depending on the predetermined installation situation, the coaxial heat exchanger tube according to the mutual fixing of inner and outer tube according to the invention can also be subjected to a total forming operation in order to adapt the heat exchanger tube to the constructional conditions of the motor vehicle or its air conditioner. Here it is true that with shorter spacings of stampings adjacent in tube longitudinal direction increasingly smaller bending radii of the coaxial tube can be realized.

In a further embodiment additionally relates to a method for manufacturing a tubular heat exchanger for a motor vehicle air conditioner. An inner tube is positioned in an outer tube and subsequently a number of local stampings radially directed inwardly are worked into the outer tube. By working the stampings into the outer tube the inner tube is positioned in radial direction relative to the outer tube and preferentially fixed non-positively, but at least in radial direction to the outer tube. Here it is more preferably provided that in a predetermined cross-sectional plane perpendicularly to the tube longitudinal extension several stampings arranged distributed in circumferential direction of the outer tube are worked into the outer tube substantially simultaneously. Through the simultaneous and preferentially uniform introduction into the outer tube the inner tube is preferentially positioned concentrically to the outer tube and through the stampings of the outer tube radially protruding inwardly also at least non-positively fixed and fastened relative to said outer tube.

Furthermore it can be provided that the stampings are worked into the outer tube so deep that on the inner tube, particularly on the inner tube wall, corresponding inner tube stampings radially directed inwardly, are created. With such stampings, inner and outer tube can be positively interconnected. In addition, through the inner tube stampings protruding into the cross section of the inner tube through which a flow can flow a swirling of the fluid, gas or fluid-gas mixture flowing in the inner tube which is advantageous for the purposes of the heat exchanger can be promoted.

In a further embodiment, a motor vehicle air conditioner with a closed refrigerant circuit, fluidically connecting at least one compressor, one condenser, one expansion device and one evaporator of the air conditioner. The refrigerant circuit or the air conditioner in this case comprises a heat exchanger according to the aforementioned embodiment. The inner tube of the heat exchanger fluidically connects the evaporator to the compressor and the outer tube of the heat exchanger, the condenser and the expansion device. The refrigerant flows flowing in the inner tube and in the intermediate space between inner tube and outer tube in this case are preferably directed opposite to each other in order to optimize the exchange of thermal energy between the inner tube and the intermediate space. Depending on design and configuration of the air conditioner and the refrigerant circuit an inverted coupling of inner tube and outer flow channel to the components evaporator and compressor or condenser and expansion device of the air conditioner is also conceivable in principle.

In addition, a motor vehicle is provided that comprises the previously described air conditioner and/or a coaxial tube heat exchanger according to aforementioned embodiments.

### BRIEF DESCRIPTION OF THE DRAWINGS

The present invention will hereinafter be described in conjunction with the following drawing figures, wherein like numerals denote like elements, and:

FIG. 1 a perspective representation of the coaxial tube heat exchanger according to an embodiment of the invention;

FIG. 2 a cross-sectional representation of the heat exchanger in the cross-sectional plane A-A according to FIG. 1;

FIG. 3 a part representation of a longitudinal section of the heat exchanger tube according to FIG. 1;

FIG. 4 a longitudinal section through a version of the heat exchanger tube; and

FIG. 5 a perspective partly cut representation of a heat exchanger tube with stampings formed at various depths.

### DETAILED DESCRIPTION

The following detailed description is merely exemplary in nature and is not intended to limit application and uses. Furthermore, there is no intention to be bound by any theory presented in the preceding background or summary or the following detailed description.

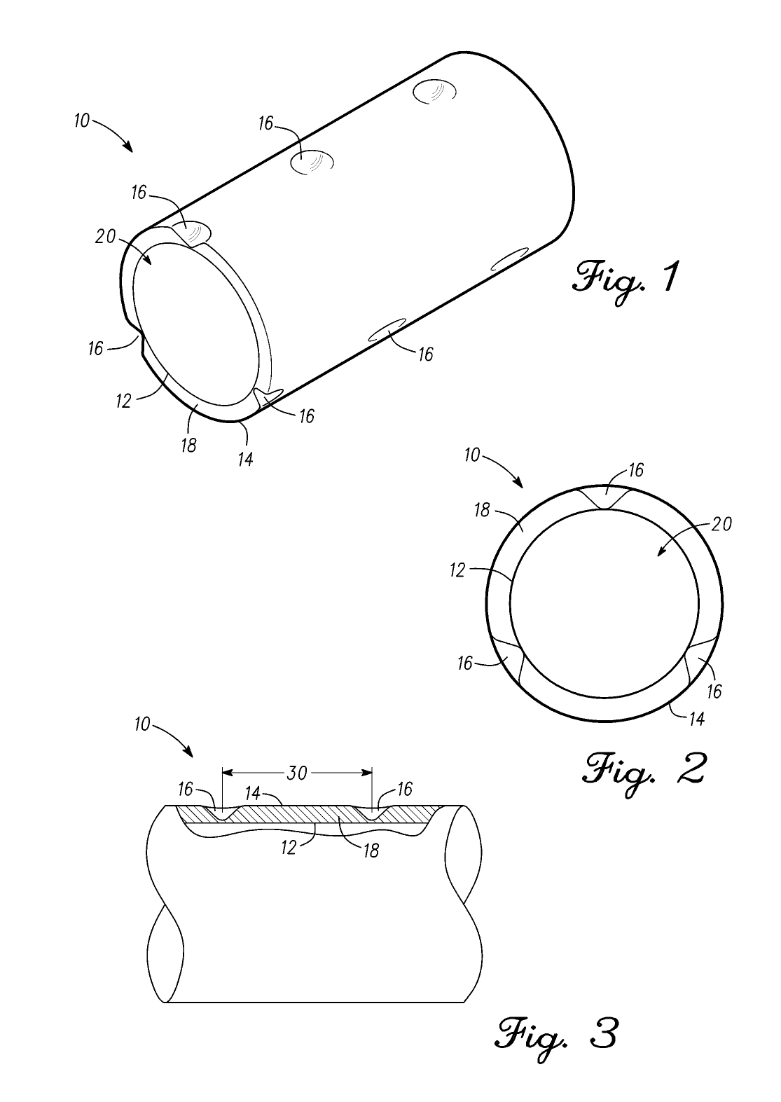

The tubular heat exchanger 10 schematically shown in perspective representation in FIG. 1 comprises an inner tube 12 and an outer tube 14 which are arranged located coaxially within one another. Distributed over the circumference of the outer tube 14, several plastic stampings 16 are provided which approximately concentrically position the inner tube 12 relative to the outer tube 14 and fix the position of both tubes 12, 14 relative to each other.

The individual stampings 16 are worked into the outer tube 14 locally directed radially inwardly. The stamping depth in this case substantially corresponds to the intermediate space gap dimension between inner tube 12 and outer tube 14 with a concentric arrangement of the two tubes 12, 14 relative to each other.

The inner space 20 of the inner tube 12 as well as the intermediate space 18 formed between the tubes 12, 14 in each case can be subjected to a refrigerant flow in opposing directions circulating in a closed refrigerant circuit of an air conditioner in order to promote an exchange of thermal energy between the refrigerants.

FIG. 2 shows a cross-sectional plane of the coaxial tube heat exchanger 10 running perpendicularly to the tube longitudinal direction along the section line A-A according to FIG. 1. By means of the cross section it is evident that altogether three stampings 16 equidistantly arranged distributed over the outer tube 14 and radially directed inwardly are formed. The spacing of stampings 16 adjacent in tube circumferential direction in this case preferentially amounts to 360° divided by the number of the stampings to be provided in the respective one cross-sectional plane.

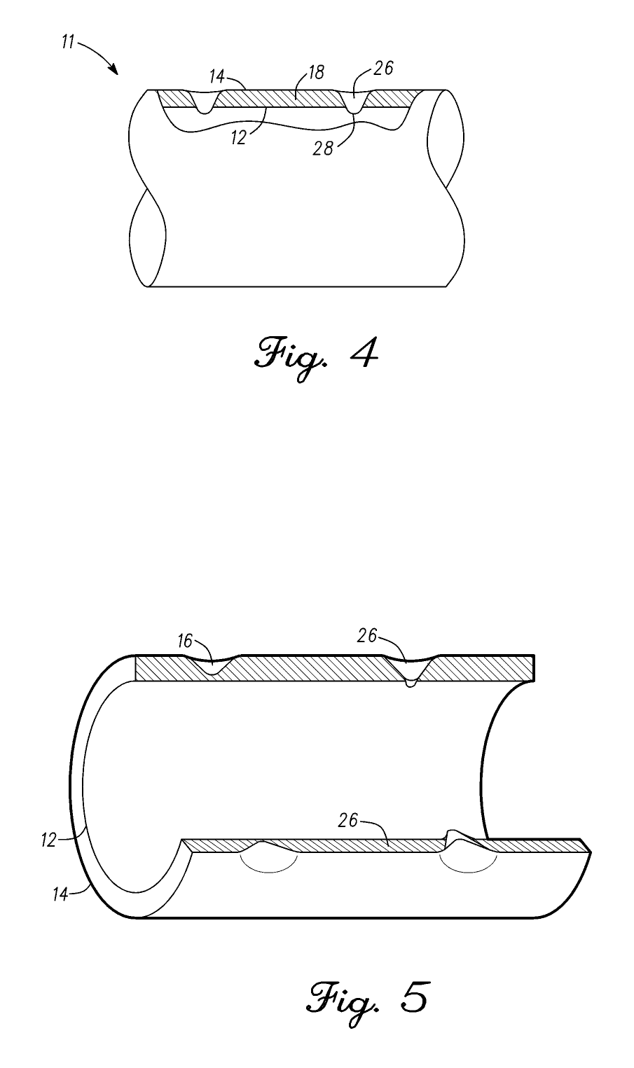

In the region of the stampings 16 the outer tube material is plastically deformed in order to be able to provide a permanent non-positive connection of outer tube 14 and inner tube 12. Alternatively to the stampings 16 shown in FIG. 1 it is additionally conceivable to work stampings 26 that go far deeper into the outer tube 14, as is indicated in FIG. 4.

Such deeper stampings 26 in this case can cause a corresponding stamping 28 on the inner tube 12, so that on the inner wall of the inner tube 12 stampings 28 radially protruding inwardly are formed. These stampings 28 or protrusions can contribute to a swirling of the fluid or gas flowing in the interior 20 of the inner tube 12 favoring the thermal energy exchange.

In addition, with a tube portion 11 of the configuration shown in FIG. 4 through the inter-engagement at least in certain regions of the stampings 26, 28 worked into the outer tube 14 and into the inner tube 12 a positive connection of inner tube 12 and outer tube 14 can be created.

The spacing 30 between stampings 16 arranged adjacently in tube longitudinal direction amounts to between 10 and 30 mm, preferentially to between 15 and 25 mm. advantageously the stampings 16 are worked at least into the outer tube 14 at substantially equidistant spacings in tube longitudinal direction. Each stamping 16 in this case forms a kind of support point for the inner tube 12. The spacing of stampings 16 in axial direction to be preferentially selected allows a universal further shaping of the coaxial tube. This can for example be bent in any directions and adapted to the installation situation in the motor vehicle, while a spacing 30 between the stampings 16 adjacent in longitudinal direction is to be selected in such a manner that the intermediate space 18 between the concentrically arranged tubes 12, 14 with a bending of the tube heat exchanger 10 can still be subjected to a through flow and is not kinked.

The merely concentrated and local supporting of the inner tube 12 by the stampings 16 protruding inwardly additionally favors the fluid flow in the tube intermediate space 18. The fluid or gas flowing in the intermediate space henceforth does not flow in individual chambers running linearly or helically in tube longitudinal direction as in the prior art, but can comparatively freely swirl distributed over the entire circumference of the inner tube.

Although in FIG. 1 and FIG. 5 stampings 16, 26 adjacent in longitudinal direction are arranged linearly relative to each other corresponding to the centre longitudinal axis of the tube 12, 14, other configurations can also be realized within the scope of the invention, wherein stampings 16, 26 adjacent in tube longitudinal direction are arranged offset to one another in circumferential direction.

In terms of manufacturing it is provided that the two tubes 12, 14 substantially designed cylindrically are inserted into each other and, subject to axial fixing if required, a press tool with suitable stamping dies acts on the outer tube 14 such that the stampings 16 arranged regularly and distributed equidistantly in circumferential direction shown in FIG. 2 are substantially worked into the outer tube 14 substantially uniformly and substantially simultaneously.

In this manner, the inner tube 12 during the course of the stamping process can be concentrically positioned to the outer tube 14 and upon completion of the stamping process also fixed non-positively and/or positively relative to said outer tube.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A heat exchanger for an air conditioner of a motor vehicle, comprising:
an inner tube configured to receive a flow of a fluid;
an outer tube radially enclosing the inner tube;
an intermediate space between the inner tube and the outer tube configured to receive a second flow of a second fluid;
a plurality of stampings radially worked into the outer tube and configured to at least radially fix the outer tube to the inner tube.

2. The heat exchanger according to claim 1, wherein the fluid is a gas.

3. The heat exchanger according to claim 1, wherein the outer tube is plastically deformed in a region of the plurality of stampings.

4. The heat exchanger according to claim 1, wherein the plurality of stampings form a non-positive connection of the outer tube and the inner tube.

5. The heat exchanger according to claim 1, wherein a stamping depth of the plurality of stampings worked into the outer tube is greater than a clear spacing between the outer tube and the inner tube.

6. The heat exchanger according to claim 4, wherein the plurality of stampings in at least certain regions lie with corresponding stampings of the inner tube.

7. The heat exchanger according to claim 4, wherein the plurality of stampings worked into the outer tube are identifiable in a form of inner wall protrusions on an inside of the inner tube.

8. The heat exchanger according to claim 1, further comprising several stampings distributed in a circumferential direction in a plane perpendicularly to a tube longitudinal extension.

9. The heat exchanger according to claim 1, further comprising several stampings spaced from one another in a tube longitudinal direction.

10. The heat exchanger according to claim 9, wherein the several spacings correspond to 5 to 15 times a radial extension of an intermediate space gap dimension between the inner tube and the outer tube.

11. The heat exchanger according to claim 9, wherein the several spacings correspond to 10 times a radial extension of an intermediate space gap dimension between the inner tube and the outer tube.

12. The heat exchanger according to claim 1, wherein spacing of the plurality of stampings amounts to between approximately 10 mm and approximately 30 mm.

13. The heat exchanger according to claim 1, wherein spacing of the plurality of stampings amounts to between approximately 15 mm and approximately 25 mm.

14. A method for manufacturing a tubular heat exchanger for an air conditioner of a motor vehicle air conditioner, comprising:
positioning an inner tube in an outer tube; and
working a plurality of stampings locally directed radially inwardly into the outer tube in order to form an at least radial fixing of the outer tube and the inner tube.

15. The method according to claim 14, wherein the at least radial fixing is a non-positive connection.

16. The method according to claim 14, further comprising distributing several stampings in a circumferential direction of the outer tube and located in a plane perpendicularly to a tube longitudinal extension

17. The method according to claim 14, working the plurality of stampings into the outer tube at a deep such that a plurality of inner tube stampings on the inner tube are created that are radially directed inwardly.

18. A motor vehicle air conditioner, comprising:
a compressor;
a condenser;
an expansion device;
an evaporator;
a closed refrigerant circuit fluidically interconnecting the compressor, the condenser, the expansion device, and the evaporator; and a heat exchanger comprising:
an inner tube fluidically interconnecting the evaporator and the compressor;
an outer tube fluidically interconnecting the condenser and the expansion device;
an intermediate space between the inner tube and the outer tube configured to receive a second flow of a second fluid; and
a plurality of stampings radially worked into the outer tube and configured to at least radially fix the outer tube to the inner tube.

19. The heat exchanger according to claim 18, wherein the outer tube is plastically deformed in a region of the plurality of stampings.

20. The heat exchanger according to claim 18, wherein the plurality of stampings form a non-positive connection of the outer tube and the inner tube.
